(19) United States
(12) Patent Application Publication
(10) Pub. No.: US 2008/0145081 A1
(43) Pub. Date: Jun. 19, 2008

(54) IMAGE FORMING APPARATUS AND CONTROL METHOD THEREOF

(75) Inventors: Ji Hoon Woo, Hwaseong-si (KR); Yong Su Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/869,092

(22) Filed: Oct. 9, 2007

(30) Foreign Application Priority Data
Dec. 18, 2006 (KR) 2006-129448

(51) Int. Cl. G03G 15/16

(52) U.S. Cl. 399/66; 399/101; 399/302

(57) ABSTRACT

An image forming apparatus and a control method thereof are disclosed. The image forming apparatus includes a plurality of photosensitive, an intermediate transfer belt which contacts the photosensitive bodies and transfers developed toner images to a paper, a first transfer roller, a second transfer roller, a cleaning blade which removes residual toner from the intermediate transfer belt after transfer, and a control unit for controlling the intermediate transfer belt. If a print command is input, the control unit drives the intermediate transfer belt, and calculates an intermediate transfer belt moving time (T1) from a distance between a nip point (P1) of the intermediate transfer belt and the second transfer roller and a contact point (P2) of the intermediate transfer belt and the cleaning blade and a linear velocity of the intermediate transfer belt. If it is determined that an image first edge position (E2) on the intermediate transfer belt passes by the nip point (P1), the control unit determines whether a moving time of the image first edge position (E2) reaches the intermediate transfer belt moving time (T1). If it is determined that the moving time of the image first edge position (E2) reaches the intermediate transfer belt moving time (T1), the control unit controls the intermediate transfer belt to be stopped.

### CROSS-REFERENCE TO RELATED APPLICATION

This application claims the benefit of Korean Application No. 2006-129448, filed Dec. 18, 2006, in the Korean Intellectual Property Office, the disclosure of which is incorporated herein by reference.

### BACKGROUND OF THE INVENTION

1. Field of the Invention

Aspects of the present invention relate to an image forming apparatus, and a control method.

2. Description of the Related Art

Generally, an image forming apparatus is an apparatus that prints an image on a printable medium, according to an input image signal. For example, the image forming apparatus can be an electrophotographic image forming apparatus that is configured to scan a light beam onto a photosensitive member charged with an electric potential, to form an electrostatic latent image thereon. The electrostatic latent image is developed into a toner image using a toner, and the toner image is transferred and fixed onto a printable medium (e.g. paper).

Korean Patent Laid-open Publication No. 2006-82193 discloses one example of a conventional image forming apparatus. The disclosed conventional image forming apparatus includes: a plurality of development cartridges for color printing; an exposure unit to form an electrostatic latent image on respective photosensitive drums; a transfer belt, which feeds paper while contacting the photosensitive drums; a transfer roller, which transfers a toner image formed on the photosensitive drums onto the paper fed by the transfer belt; and a cleaning blade to clean the transfer belt. The cleaning blade is pressed against the transfer belt, to remove residual toner from the transfer belt.

In the above conventional image forming apparatus, when a printing process is finished, the transfer belt is further circulated, so that the cleaning blade can completely clean residual developer from the transfer belt. If a next printing command is input, a clean portion of the transfer belt, from which the residual developer is removed, passes by and is contacted by the cleaning blade, thereby excessively stressing the cleaning blade. The cleaning blade, which is made of soft synthetic resin material, is subjected to excessive stress and is occasionally turned over. Therefore, the cleaning blade can fail to clean the transfer belt. Even if the cleaning blade is not turned over, the lifespan thereof is decreased by excessive friction.

### SUMMARY OF THE INVENTION

Aspects of the present invention are directed to solving the above and/or other problems. Aspects of the invention provide an image forming apparatus and a control method thereof, which can minimize the contact of a cleaning blade and portions of an intermediate transfer belt that do not contain developer, thereby improving the lifespan and reducing turnover of the cleaning blade, preventing image deterioration, and increasing operational efficiency.

An exemplary embodiment of the present invention provides an image forming apparatus including: a plurality of photosensitive bodies, on which electrostatic latent images are formed; an intermediate transfer belt, which contacts the photosensitive bodies and transfers developed toner images to a paper; a first transfer roller; a second transfer roller; and a cleaning blade, which removes residual developer from the intermediate transfer belt after transfer. The image forming apparatus comprises: a control unit to control the intermediate transfer belt, in response to a print command. The control unit drives the intermediate transfer belt, calculates an intermediate transfer belt moving time (T1), which is the time period during which a paper first edge position (E1) of the intermediate transfer belt reaches the cleaning blade. The control unit also controls the intermediate transfer belt, such that the paper first edge position (E1) is stopped near the cleaning blade.

The intermediate transfer belt moving time (T1) is derived from a distance between a nip point (P1), which is a contact point of the intermediate transfer belt and the second transfer roller, a contact point (P2), which is a contact point of the intermediate transfer belt and the cleaning blade, and a linear velocity of the intermediate transfer belt.

If a print time (T2) is shorter than the intermediate transfer belt moving time (T1), the control unit controls the intermediate transfer belt to be further driven for a time difference (T1-T2) and then to be stopped. If the print time (T2) is longer than the intermediate transfer belt moving time (T1), the control unit controls the intermediate transfer belt to be stopped when the print time (T2) has elapsed.

The control unit derives an actual image arriving time (T3) from an interval between the paper first edge position (E1), an image first edge position (E2), which is a position on the intermediate transfer belt on which developer remains, and the linear velocity of the intermediate transfer belt. If the control unit determines that the paper first edge position (E1) reaches the contact point (P2), of the intermediate transfer belt and the cleaning blade, the control unit controls the intermediate transfer belt to be further driven for the actual image arriving time (T3) and then stopped, so that the image first edge position (E2) is located near the cleaning blade.

An exemplary embodiment of the present invention provides an image forming apparatus including: a plurality of photosensitive bodies, on which electrostatic latent images are formed; an intermediate transfer belt, which contacts the photosensitive bodies and transfers developed toner images to a paper; a first transfer roller; a second transfer roller; and a cleaning blade, which removes residual developer present the intermediate transfer belt, after transfer. The image forming apparatus comprises a control unit to control the intermediate transfer belt. If a print command is input, the control unit starts the intermediate transfer belt and derives an intermediate transfer belt moving time (T1). The intermediate transfer belt moving time (T1) can be derived from a distance between a nip point (P1), which is a point of contact between the intermediate transfer belt and the second transfer roller, a contact point (P2), which is a point of contact between the intermediate transfer belt and the cleaning blade, and a linear velocity of the intermediate transfer belt. When an image first edge position (E2), on the intermediate transfer belt, passes by the nip point (P1), the control unit determines whether a moving time of the image first edge position (E2) reaches the intermediate transfer belt moving time (T1). If the control unit determines that the moving time of the image first edge position (E2) reaches the intermediate transfer belt moving time (T1), the control unit stops the intermediate transfer belt.

An exemplary embodiment of the present invention provides a method for controlling an image forming apparatus including: a plurality of photosensitive bodies, on which electrostatic latent images are formed; an intermediate transfer belt, which contacts the photosensitive bodies and transfers developed toner images to a paper; a first transfer roller; a second transfer roller; and a cleaning blade, which removes residual developer from the intermediate transfer belt after transfer. The method includes:, driving the intermediate transfer belt to transfer the toner images to the paper, if a print command is input; calculating an intermediate transfer belt moving time (T1), during which the paper first edge position (E1) reaches the cleaning blade; and stopping the intermediate transfer belt when the paper first edge position (E1) is located at or near the cleaning blade. If a next print command is input, the intermediate transfer belt is driven, so that the residual developer on the intermediate transfer belt is removed, and then an additional toner image transfer is performed.

According to various embodiments, provided is a method comprising: a) driving the intermediate transfer belt; b) calculating an intermediate transfer belt moving time (T1) from a distance between a nip point (P1) of the intermediate transfer belt and the second transfer roller and a contact point (P2) of the intermediate transfer belt and the cleaning blade, and a linear velocity of the intermediate transfer belt; c) determining whether a moving time of the paper first edge position (E1) on the intermediate transfer belt equals the intermediate transfer belt moving time (T1); and d) if it is determined that the moving time of the paper first edge position (E1) equals the intermediate transfer belt moving time (T1), stopping the intermediate transfer belt.

The determining c) includes: e) calculating an actual image arriving time (T3) from an interval between the paper first edge position (E1) and an image first edge position (E2), which is a position on the intermediate transfer belt at which toner remains, and the linear velocity of the intermediate transfer belt; f) determining whether the moving time of the paper first edge position (E1) equals the intermediate transfer belt moving time (T1); and g) if it is determined that the moving time of the paper first edge position (E1) equals the intermediate transfer belt moving time (T1), driving the intermediate transfer belt for a actual image arriving time (T3) and then stopping the intermediate transfer belt.

An exemplary embodiment of the present invention provides a method for controlling an image forming apparatus including: a plurality of photosensitive bodies, on which electrostatic latent images are formed; an intermediate transfer belt, which contacts the photosensitive bodies and transfers developed toner images to a paper; a first transfer roller; a second transfer roller; and a cleaning blade, which removes residual developer on the intermediate transfer belt after transfer. The method includes: a) driving the intermediate transfer belt; b) calculating an intermediate transfer belt moving time (T1) from a distance between a nip point (P1), of the intermediate transfer belt and the second transfer roller, and a contact point (P2) of the intermediate transfer belt and the cleaning blade, and a linear velocity of the intermediate transfer belt; c) determining whether an image first edge position (E2) on the intermediate transfer belt passes by the nip point (P1); d) if it is determined that the image first edge position (E2) passes by the nip point (P1), determining whether a moving time of the image first edge position (E2) reaches the intermediate transfer belt moving time (T1); and e) if it is determined that the moving time of the image first edge position (E2) reaches the intermediate transfer belt moving time (T1), stopping the intermediate transfer belt.

Additional aspects and/or advantages of the invention will be set forth in part in the description which follows, and in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating an image forming apparatus, in accordance with an exemplary embodiment of the present invention;

FIG. 2 is a block diagram of an image forming apparatus, in accordance with an exemplary embodiment of the present invention;

FIG. 3 is a flow chart of a method for controlling an image forming apparatus, in accordance with an exemplary embodiment of the present invention; and

FIGS. 4 and 5 are schematic views illustrating a developing unit of an image forming apparatus, in accordance with an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

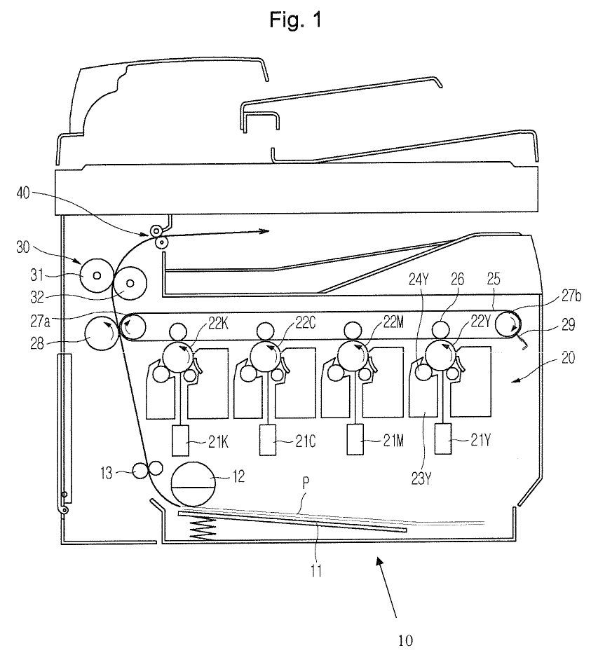

FIG. 1 is a schematic view illustrating an image forming apparatus 100, in accordance with an exemplary embodiment of the present invention. As shown in FIG. 1, the image forming apparatus 100 includes a paper feeding unit 10 to supply a paper P, a developing unit 20 to develop an image on the paper P, a fixing unit 30 to fix the image on the paper P by applying heat and pressure to the paper P, and a discharge unit 40 to discharge the paper P having the fixed image.

The paper feeding unit 10 includes: a paper feeding tray 11, on which the paper P is loaded; a pickup roller 12, which picks up individual sheets of the paper P loaded on the tray 11; and a feed roller 13, which feeds the picked-up paper toward the developing unit 20.

The developing unit 20 includes: a plurality of photosensitive bodies 22Y, 22M, 22C, and 22K (hereinafter, Y, M, C and K will be omitted), on which electrostatic latent images are formed by the respective exposure units 21; toner cartridges 23, in which, for example, black (B) toner, cyan (C) toner, magenta (M) toner and yellow (Y) toner are respectively stored; developing rollers 24, which receive the toner from the toner cartridges 23 and develop the electrostatic latent images on the photosensitive bodies 22 into toner images; an intermediate transfer belt 25; first transfer rollers 26; and a second transfer roller 28.

The intermediate transfer belt 25 is supported by the supporting rollers 26, 27a, and 27b, and runs at the same velocity as a linear velocity of the rotating photosensitive bodies 22. The first transfer rollers 26 oppose the respective photosensitive bodies 22, and transfer the toner images, developed on the photosensitive bodies 22, to the intermediate transfer belt 25. The second transfer roller 28 is disposed opposite to the driving roller 27a, which drives the intermediate transfer belt 25. While the toner images are transferred to the intermediate transfer belt 25, from the photosensitive bodies 22, the second transfer roller 28 is spaced apart from the intermediate transfer belt 25. When the toner images are completely transferred to the intermediate transfer belt 25, the second transfer roller 28 comes into contact with the intermediate transfer belt 25, with a prescribed pressure. A cleaning blade 29 is provided near the tension roller 27b, which supports the intermediate transfer belt 25 while contacting the intermediate transfer belt 25 with a prescribed pressure, so as to scrape away residual toner from the intermediate transfer belt 25, after the transfer of the toner image. The removed toner is collected in a storage part (not shown).

The fixing unit 30 includes a heat roller 31 to heat the toner-transferred paper, and a press roller 32, which is disposed opposite to the heat roller 31 and maintains a constant fixing pressure with the heat roller 31. The discharge unit 40 includes discharge rollers, which are sequentially mounted so as to discharge the paper P, which has passed by the fixing unit 30, out of a main body of the image forming apparatus 100.

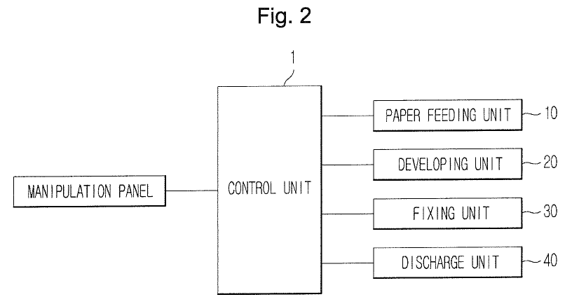

FIG. 2 is a block diagram of the image forming apparatus, according to aspects of the present invention. As shown in the drawing, the image forming apparatus includes a control unit 1 to control the paper feeding unit 10, the developing unit 20, the fixing unit 30, and the discharge unit 40, in response to a print command input through a manipulation panel (not shown).

Hereinafter, an operation of the image forming apparatus 100, according to aspects of the present invention, will be described. If a print command is input, the control unit 1 controls the image forming apparatus, such that the pickup roller 12 picks up the paper P loaded in the paper tray 11. The toner images are formed on the photosensitive bodies 22 of the developing unit 20. The toner images on the photosensitive bodies 22 are transferred to the intermediate transfer belt 25. The toner images on the intermediate transfer belt 25 are transferred again to the paper P passing between the second transfer roller 28 and the intermediate transfer belt 25. The toner images transferred to the paper are fixed to the paper P, while the paper P passes through the fixing unit 30. The paper P is then discharged through the discharge unit 40.

When the transfer of the toner image from intermediate transfer belt 25 is completed, the control unit 1 controls the intermediate transfer belt 25 to be further circulated. The cleaning blade 29 can then remove the residual developer from the intermediate transfer belt 25.

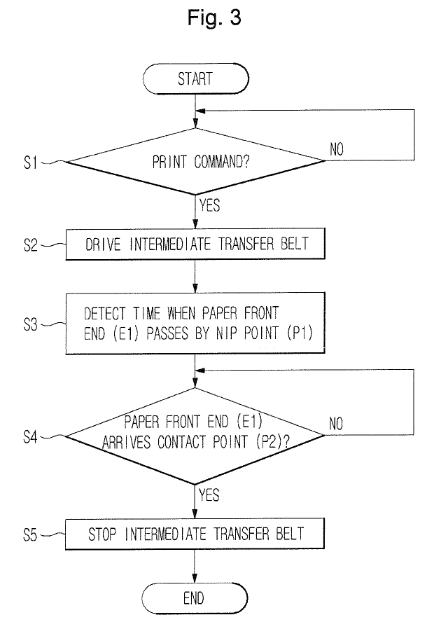

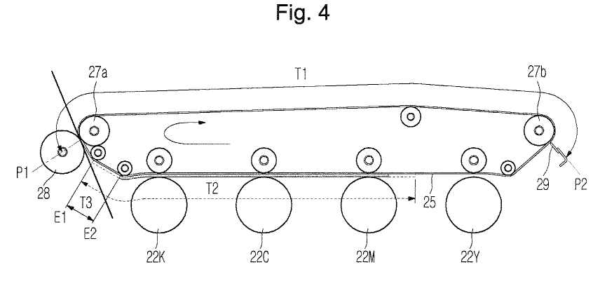

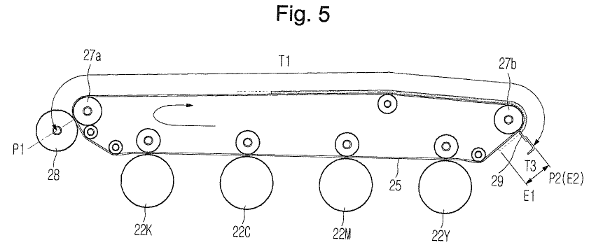

FIG. 3 is a flow chart showing a control process by which the control unit 1 controls the intermediate transfer belt 25. FIGS. 4 and 5 are views schematically illustrating the developing unit, to explain the control process.

If a print command is input, the control unit 1 starts the intermediate transfer belt 25 to transfer the toner images. The control unit 1 calculates an intermediate transfer belt moving time T1, during which a paper first edge position E1 reaches the cleaning blade after the transfer. The control unit 1 stops the intermediate transfer belt 25, when the paper first edge position E1 is at or near the cleaning blade, before the next transfer is performed. The paper first edge position E1 refers to a region of the intermediate transfer belt 25 that contacts a first edge of a paper, when transferring an image thereto. The paper can be a standard size paper, for example, A4, B5, 8.5×11, or the like. The paper can be any printable medium including transparencies or any sized paper. An image first edge position E2 refers to a first line, or beginning, of a toner image on the intermediate transfer belt 25. The intermediate transfer belt moving time T1 is derived from a distance between a nip point P1 and a contact point P2, and a linear velocity of the intermediate transfer belt 25. The nip point P1 is a point where the intermediate transfer belt 25 contacts the second transfer roller 28, and the contact point P2 is a point where the cleaning blade 29 contacts the intermediate transfer belt 25.

If the print command is input during operation S1, the control unit 1 starts the intermediate transfer belt 25. During operation S2 toner images, for example, yellow, magenta, cyan, and black toner images, are formed on the respective photosensitive bodies 22, and the intermediate transfer belt 25 is driven, so that the toner images are transferred to the intermediate transfer belt 25.

In operation S3, the control unit 1 detects a time when the paper first edge position E1 passes by the nip point P1. In operation S4, the control unit 1 determines whether the paper first edge position E1 reaches the contact point P2.

In operation S5, if the paper first edge position E1 reaches the contact point P2, the control unit 1 stops the intermediate transfer belt 25. If a print time T2, during which the toner images on the intermediate transfer belt 25 are completely transferred to the paper P, is shorter than the intermediate transfer belt moving time T1, the control unit 1 controls the intermediate transfer belt 25 to be further driven for a time difference of (T1-T2) and then stops the intermediate transfer belt 25. If the print time T2 is longer than the intermediate transfer belt moving time T1, the control unit 1 controls the intermediate transfer belt 25 to be stopped when the print time T2 elapses. In both cases, since the paper first edge position E1 is located adjacent to the cleaning blade 29, the distance over which the cleaning blade 29 contacts the intermediate transfer belt 25 can be reduced, without leaving behind any residual toner.

The control unit 1 may stop the intermediate transfer belt 25 when the image first edge position E2 approaches the cleaning blade, by deriving an actual image arriving time T3. The actual image arriving time T3 is derived from a distance between the paper first edge position E1 and the image first edge position E2, and the linear velocity of the intermediate transfer belt 25. In other words, during the operation of the intermediate transfer belt 25, if it is determined that the paper first edge position E1 has reached the contact point P2, in operation S4, the control unit 1 controls the intermediate transfer belt 25 to be further driven for the pre-calculated actual image arriving time T3 and then stopped.

In the above-described embodiment of the present invention, the paper first edge position E1 is used as a reference for detecting the position of the image first edge position E2, however, the present invention is not restricted thereto. Aspects of the present invention include controlling the intermediate transfer belt 25 by directly detecting the position of the image first edge position E2.

As is apparent from the above description, after the transfer of the toner image, a portion of the intermediate transfer belt, on which the residual toner remains, is moved near the cleaning blade before the next toner transfer is performed. Accordingly, the distance over which the cleaning blade contacts a toner-free portion of intermediate transfer belt can be minimized.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus including a plurality of photosensitive bodies on which electrostatic latent images are formed, an intermediate transfer belt to contact the photosensitive bodies and transfer a toner image to a paper, a first transfer roller, a second transfer roller, and a cleaning blade to remove residual toner from the intermediate transfer belt, the apparatus comprising a control unit to:
start the intermediate transfer belt in response to a print command; to calculate an intermediate transfer belt moving time (T1) during which a paper first edge position (E1) on the intermediate transfer belt reaches the cleaning blade; and
stop the intermediate transfer belt when the paper first edge position (E1) is disposed adjacent to the cleaning blade,
wherein the paper first edge position (E1) is a position on the intermediate transfer belt where a first edge of the paper is disposed during the transfer of the toner image.

2. The image forming apparatus according to claim 1, wherein the controller calculates the intermediate transfer belt moving time (T1) according to:
a distance between a nip point (P1) where the intermediate transfer belt contacts and the second transfer roller and a contact point (P2) where the intermediate transfer belt contacts the cleaning blade; and
a linear velocity of the intermediate transfer belt.

3. The image forming apparatus according to claim 2, wherein:
the control unit is to compare a print time (T2) to the intermediate transfer belt moving time (T1); and
the print time (T2) is a time period during which the toner image is transferred to the paper.

4. The image forming apparatus according to claim 2, wherein the control unit is to: derive an actual image arriving time (T3) according to an interval between the paper first edge position (E1) and an image first edge position (E2), and the linear velocity of the intermediate transfer belt,
wherein the image first edge position (E2) is a position on the intermediate transfer belt where a first edge of the toner image is disposed; and
stop the intermediate transfer belt when the image first edge position (E2) is located adjacent to the cleaning blade in accordance with the actual image arriving time (T3).

5. An image forming apparatus including a plurality of photosensitive bodies on which electrostatic latent images are formed, an intermediate transfer belt which contacts the photosensitive bodies and transfers a toner image to a paper, a first transfer roller, a second transfer roller and a cleaning blade which removes residual toner from the intermediate transfer belt after transfer, the image forming apparatus comprising a control unit to:
start the intermediate transfer belt in response to an input print command;
derive an intermediate transfer belt moving time (T1) according to a distance between a nip point (P1) where the intermediate transfer belt contacts the second transfer roller and a contact point (P2) where the intermediate transfer belt contacts the cleaning blade, and a linear velocity of the intermediate transfer belt; determine whether a moving time of the image first end position (E2) reaches the intermediate transfer belt moving time (T1), in accordance with when an image first end (E2) on the intermediate transfer belt passes by the nip point (P1); and
stop the intermediate transfer belt if the moving time of the image first end position (E2) reaches the intermediate transfer belt moving time (T1).

6. A method of controlling an image forming apparatus including a plurality of photosensitive bodies on which electrostatic latent images are formed, an intermediate transfer belt which contacts the photosensitive bodies and transfers toner images to a paper, a first transfer roller, a second transfer roller and a cleaning blade which removes residual toner on the intermediate transfer belt after transfer, the method comprising:
driving the intermediate transfer belt to transfer the toner images to the paper in response to a first input print command;
calculating an intermediate transfer belt moving time (T1) during which a paper first edge position (E1) on the intermediate transfer belt reaches the cleaning blade; and
stopping the intermediate transfer belt when a paper first edge position (E1) is disposed adjacent to the cleaning blade; and
driving the intermediate transfer belt to remove the residual toner from the intermediate transfer belt in response to a second input print command.

7. The method according to claim 6, comprising:
determining whether a moving time of the paper first edge position (E1) reaches the intermediate transfer belt moving time (T1); and
stopping the intermediate transfer belt if the moving time of the paper first edge position (E1) reaches the intermediate transfer belt moving time (T1).

8. The method according to claim 7, wherein the determining comprises:
calculating an actual image arriving time (T3) using an interval between the paper first edge position (E1) and an image first edge position (E2), which a position on which toner remains on the intermediate transfer belt, and the linear velocity of the intermediate transfer belt;
determining whether the moving time of the paper first edge position (E1) reaches the intermediate transfer belt moving time (T1); and
if determined that the moving time of the paper front end (E1) reaches the intermediate transfer belt moving time (T1), continuing the driving of the intermediate transfer belt until the actual image arriving time (T3) elapses and then stopping the intermediate transfer belt.

9. A method of controlling an image forming apparatus including a plurality of photosensitive bodies on which electrostatic latent images are formed, an intermediate transfer belt which contacts the photosensitive bodies and transfers toner images to a paper, a first transfer roller, a second transfer roller and a cleaning blade which removes residual toner on the intermediate transfer belt after transfer, the method comprising:
driving the intermediate transfer belt;
calculating an intermediate transfer belt moving time (T1) according to a distance between a nip point (P1), which is a contact point between the intermediate transfer belt and the second transfer roller, and a contact point (P2) which is a contact point between the intermediate transfer belt and the cleaning blade, and a linear velocity of the intermediate transfer belt;
determining whether an image first edge position (E2) on the intermediate transfer belt passes by the nip point (P1);
if determined that the image first edge position (E2) passes by the nip point (P1), determining whether a moving time of the image first edge position (E2) reaches the intermediate transfer belt moving time (T1); and
if it is determined that the moving time of the image first edge position (E2) reaches the intermediate transfer belt moving time (T1), stopping the intermediate transfer belt.

10. The image forming apparatus according to claim 3, wherein the control unit is to control the intermediate transfer belt to be further driven for a time difference (T1-T2) and then stopped, if the print time (T2) is shorter than the intermediate transfer belt moving time (T1).

11. The image forming apparatus according to claim 3, wherein the control unit is to stop the intermediate transfer belt when the print time (T2) elapses, if the print time (T2) is longer than the intermediate transfer belt moving time (T1).

12. The image forming apparatus according to claim 5, wherein the controller is to stop the intermediate transfer belt when the paper first edge position (E1) is disposed adjacent to the cleaning blade.

13. The method according to claim 7, wherein the calculating of the moving time of the paper first edge position (T1) comprises using:
a distance between a nip point (P1) where the intermediate transfer belt contacts the second transfer roller, and a contact point (P2) where the intermediate transfer belt contacts the cleaning blade; and
a linear velocity of the intermediate transfer belt.

14. The method of claim 8, wherein the image first edge position (E2) is a position on the intermediate transfer belt where a first edge of the toner image is disposed.

15. A method of controlling an image forming apparatus including a plurality of photosensitive bodies on which electrostatic latent images are formed, an intermediate transfer belt which contacts the photosensitive bodies and transfers a toner image to a paper, a first transfer roller, a second transfer roller and a cleaning blade which removes residual toner from the intermediate transfer belt after transfer, the method comprising:
driving the intermediate transfer belt in response to an first input print command;
calculating an intermediate transfer belt moving time (T1) during which a paper first edge position (E1) on the intermediate transfer belt reaches the cleaning blade;
calculating an actual image arriving time (T3) during which an image first edge position (E1) on the intermediate transfer belt reaches the cleaning blade,
wherein the paper first edge position (E1) is a position on the intermediate transfer belt where a first edge of the paper is disposed during the transfer of the toner image, and the image first edge position (E2) is a position on the intermediate transfer belt where a first edge of the toner image is disposed; and
stopping the inter-mediate transfer belt:
when the actual image arriving time (T3) elapses, if the actual image time arriving time is greater than the intermediate transfer belt moving time; and
when the intermediate transfer belt moving time (T1) elapses, if the actual image arriving time is less than the intermediate transfer belt moving time.

16. The method of claim 15, wherein the calculating of the intermediate transfer belt moving time (T1) comprises using:
a distance between a nip point (P1) where the intermediate transfer belt contacts the second transfer roller, and a contact point (P2) where the intermediate transfer belt contacts the cleaning blade; and
a linear velocity of the intermediate transfer belt.

17. The method of claim 15, wherein the calculating of the actual image arriving time (T3) comprises using:
an interval between the paper first edge position (E1) and the image first edge position (E2); and
a linear velocity of the intermediate transfer belt.

18. The method of claim 15, wherein the stopping comprises stopping the paper first edge position (E1) adjacent to the cleaning blade.

19. The method of claim 15, wherein the stopping comprises stopping the image first edge position (E2) adjacent to the cleaning blade.

20. The method of claim 15, further comprising driving the intermediate transfer belt to remove the residual toner from the intermediate transfer belt in response to a second input print command.
